(19) United States
(12) Patent Application Publication
(10) Pub. No.: US 2014/0237629 A1
(43) Pub. Date: Aug. 21, 2014

(54) ELECTRONIC COMMUNICATION

(71) Applicant: SAAS Document Solutions Limited, Youghal (IE)

(72) Inventor: Raymond Michael Cork, Youghal (IE)

(73) Assignee: SAAS Document Solutions Limited, Youghal (IE)

(21) Appl. No.: 14/351,345

(22) PCT Filed: Oct. 15, 2012
(86) PCT No.: PCT/IB2012/002223

§ 371 Date: Apr. 11, 2014

(30) Foreign Application Priority Data
Oct. 14, 2011 (GB) 1117832.4

(51) Int. Cl. G06F 21/62

(52) U.S. Cl. CPC G06F 21/62; G06F 2221/2149
USPC 726/30

(57) ABSTRACT

A system 10 comprises first and second user machines 12, 14. Information content can be communicated from the first machine 12 to the second machine 14. The first machine 12 is in a first network 16. The second machine 14 is in a second network 18. Security in the second network 18 cannot be controlled from the first machine 12. The machine 12 sends information content 24 to a server 22 which stores the content 24. Content 24 is sent to the server 22 as a datastream with control content 26. The server 22 prevents access to the content 24 from the second machine 14, except by a second user authorised by the control content 26.

The present invention relates to improvements in or relating to electronic communication.

Many situations exist in which electronic communication of information content from one user machine to another user machine is required. For example, e-mail systems may be used. When an e-mail is sent, a chain of servers is used to provide communication from the sending machine to the recipient machine and a copy of the e-mail is forwarded from server to server, along the chain, until reaching the recipient machine. Consequently, copies of the e-mail typically exist at multiple positions along the chain, in addition to the recipient machine. This is undesirable in some circumstances, such as when communications relate to financial transactions or other confidential matters. In those circumstances, e-mails may be sent in a protected form, such as by encryption, with the intention that the e-mail can only be read by the intended recipient. This provides the sender with some control. However, the recipient is free to distribute the e-mail further, once decrypted. Furthermore, a continuing administrative overhead is required, to maintain passwords, encryption keys and the like, to refresh these on a regular basis, and to distribute appropriate updates to the users.

Examples of the present invention provide a system comprising first and second user machines and for providing communication of information content from the first user machine to the second user machine, the second user machine forming part of a network having security settings which are not controllable by use of the first user machine, the system further comprising:
a server;
the first user machine being operable to send information content to the server;
the server being operable to store the information content;
and wherein:
the information content is sent to the server as a datastream;
the first user machine is operable to provide control content associated with the information content; and
the server is operable to prevent access to the information content from the second user machine except by a second user authorised by the control content.

The server may be operable in accordance with the control content to prevent access except by providing an image file representative of the information content and for viewing at the second user machine. The image file may be a bitmap image file.

The server may be operable to allow the information content to be downloaded by a user authorised by the control content.

The server may be operable to store the control content in association with the information content.

The server may be operable to control operations on the information content in accordance with instructions contained in the control content.

The server may be operable to maintain a log of operations carried out in relation to the information content. The log may contain information relating to operations carried out by the second user.

The server may be operable to send link data to the second user, the link data alerting the second user to the presence of the information content. The link data may identify the location of the information content. The link data may contain a hyperlink to the information content. The link data may be sent in the form of an electronic message to the second user, such as an e-mail, SMS, MMS, voice or other message format. The link data may be sent to the second user machine or to another machine.

The first user machine may be operable from within an e-mail client to create the control content, the information content and the control content being sent by operation of the e-mail client.

The datastream may be encrypted. The datastream may be secure.

This aspect also provides a method for providing communication of information content from a first user machine to a second user machine, the second user machine forming part of a network having security settings which are not controllable by use of the first user machine, the method comprising:
providing a server;
using the first user machine to send information content to the server;
operating the server to store the information content;
and wherein:
the information content is sent to the server as a datastream;
the first user machine is used to provide control content associated with the information content; and
the server is used to prevent access to the information content from the second user machine except by a second user authorised by the control content.

The server may be operated in accordance with the control content to prevent access except by providing an image file representative of the information content and for viewing at the second user machine. The image file may provide a bitmap image file.

The server may be operated to allow the information content to be downloaded by a user authorised by the control content.

The server may store the control content in association with the information content.

The server may control operations on the information content in accordance with instructions contained in the control content.

The server may maintain a log of operations carried out in relation to the information content. The log may contain information relating to operations carried out by the second user.

The server may send link data to the second user, the link data alerting the second user to the presence of the information content. The link data may identify the location of the information content. The link data may contain a hyperlink to the information content. The link data may be sent in the form of an electronic message to the second user, such as an e-mail, SMS, MMS, voice or other message format. The link data may be sent to the second user machine or to another machine.

The first user machine may be used from within an e-mail client to create the control content, the information content and the control content being sent by operation of the e-mail client.

The datastream may be encrypted. The datastream may be secure.

Examples of the present invention also provide a first user machine for use in a system comprising first and second user machines and for providing communication of information content from the first user machine to the second user machine, the second user machine forming part of a network having security settings which are not controllable by use of the first user machine, and the system further comprising a server;
wherein the first user machine is operable to send information content to the server for storage in the server;
and wherein the information content is sent to the server as a datastream;
and wherein the first user machine is operable to provide control content associated with the information content; the information content containing instructions for the server to prevent access to the information content from the second user machine except by a second user authorised by the control content.

The first user machine may be operable from within an e-mail client to create the control content, the information content and the control content being sent by operation of the e-mail client.

The datastream may be encrypted. The datastream may be secure.

This aspect also provides a method for providing communication of information content from a first user machine to a second user machine, the second user machine forming part of a network having security settings which are not controllable by use of the first user machine, and the system further comprising a server;
the method comprising using the first user machine to send information content to the server for storage in the server;
sending the information content to the server as a datastream;
and using the first user machine to provide control content associated with the information content; the information content containing instructions for the server to prevent access to the information content from the second user machine except by a second user authorised by the control content.

The first user machine may be operable from within an e-mail client to create the control content, the information content and the control content being sent by operation of the e-mail client.

The datastream may be encrypted. The datastream may be secure.

Examples of the present invention also provide a server for use in a system comprising first and second user machines and for providing communication of information content from the first user machine to the second user machine, the second user machine forming part of a network having security settings which are not controllable by use of the first user machine,
wherein the server is operable to receive a datastream from the first user machine and to identify information content and control content within the datastream, and to store the information content, and the server is further operable to prevent access to the information content from the second user machine except by a second user authorised by the control content.

The server may be operable in accordance with the control content to prevent access except by providing an image file representative of the information content and for viewing at the second user machine. The image file may be a bitmap image file.

The server may be operable to allow the information content to be downloaded by a user authorised by the control content.

The server may be operable to store the control content in association with the information content.

The server may be operable to control operations on the information content in accordance with instructions contained in the control content.

The server may be operable to maintain a log of operations carried out in relation to the information content. The log may contain information relating to operations carried out by the second user.

The server may be operable to send link data to the second user, the link data alerting the second user to the presence of the information content. The link data may identify the location of the information content. The link data may contain a hyperlink to the information content. The link data may be sent in the form of an electronic message to the second user, such as an e-mail, SMS, MMS, voice or other message format. The link data may be sent to the second user machine or to another machine.

The server may be operable to receive an encrypted and/or secure datastream from the first user machine.

This aspect also provides a method for use in a system comprising first and second user machines and for providing communication of information content from the first user machine to the second user machine, the second user machine forming part of a network having security settings which are not controllable by use of the first user machine,
wherein the server is used to receive a datastream from the first user machine and to identify information content and control content within the datastream, and to store the information content, and the server is further used to prevent access to the information content from the second user machine except by a second user authorised by the control content.

The server may be operable in accordance with the control content to prevent access except by providing an image file representative of the information content and for viewing at the second user machine. The image file may be a bitmap image file.

The server may be operable to allow the information content to be downloaded by a user authorised by the control content.

The server may be operable to store the control content in association with the information content.

The server may be operable to control operations on the information content in accordance with instructions contained in the control content.

The server may be operable to maintain a log of operations carried out in relation to the information content. The log may contain information relating to operations carried out by the second user.

The server may be operable to send link data to the second user, the link data alerting the second user to the presence of the information content. The link data may identify the location of the information content. The link data may contain a hyperlink to the information content. The link data may be sent in the form of an electronic message to the second user, such as an e-mail, SMS, MMS, voice or other message format. The link data may be sent to the second user machine or to another machine.

The server may receive an encrypted and/or secure datastream from the first user machine.

The invention also provides computer software which, when installed on a computer system, is operable as a system or as a first user machine or as a second user machine as defined above. This aspect also provides a carrier medium carrying computer software as defined in the previous sentence.

Examples of the present invention will now be described in more detail, by way of example only, and with reference to the accompanying drawings, in which:

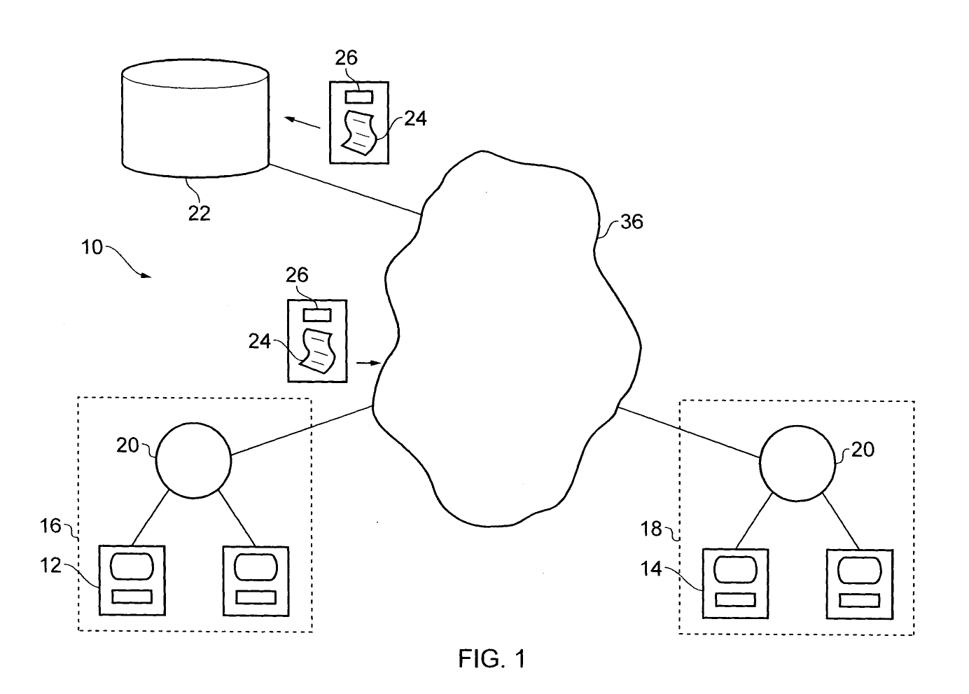

FIG. 1 is a schematic diagram illustrating an example system according to the present invention;

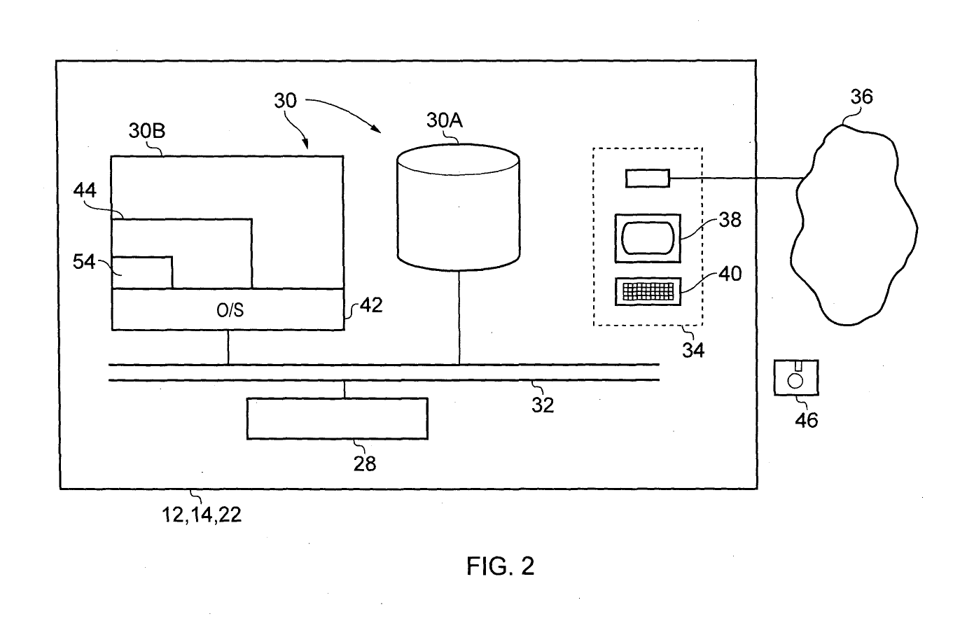

FIG. 2 is a schematic diagram of a machine for use in the system; and

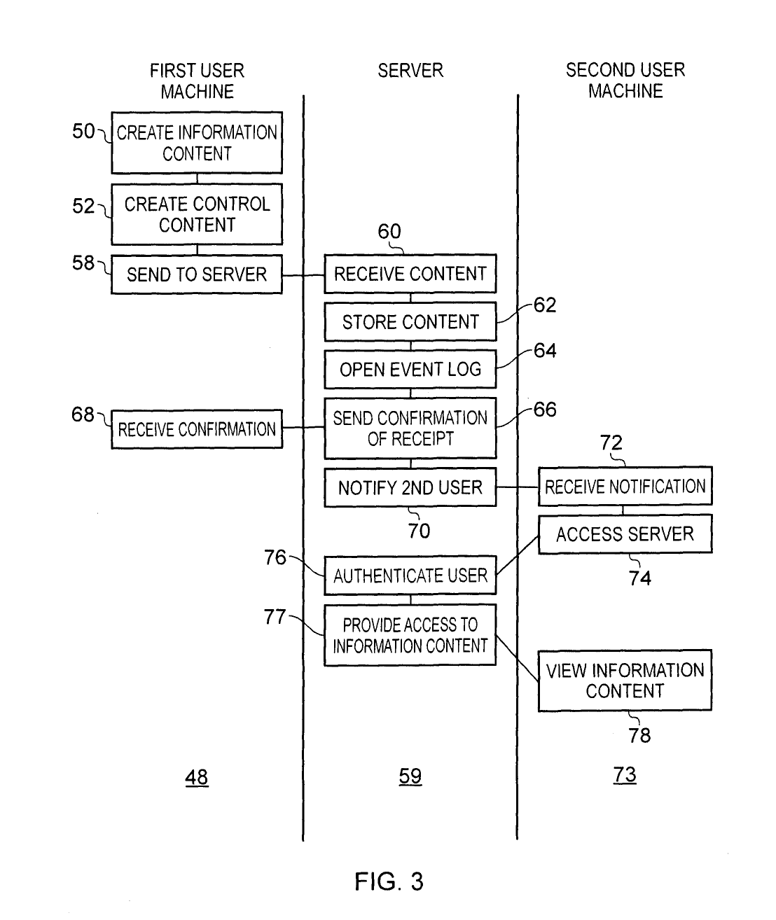

FIG. 3 is a flow diagram of operations during the use of the system.

### OVERVIEW

FIG. 1 illustrates a system 10 comprising a first user machine 12 and a second user machine 14. The system 10 is for providing communication of information content from the first user machine 12 to the second user machine 14. The first user machine 12 forms part of a first network 16. The second user machine 14 forms part of a second network 18. The second network 18 has security settings which are not controllable by use of the first user machine 12, being part of a different network 16.

In this example, both networks 16, 18 are based around servers 20 to which the user machines 12, 14 are connected. Many other network configurations could be used, including network configurations which did not incorporate a server. It is significant to note that any document control which exists within the network 18, such as control of access settings for the server 20 of the network 18, cannot be controlled from outside the network 18 and thus cannot be controlled from the first user machine 12.

The system 10 further comprises a server 22. The first user machine 12 is operable to send information content (illustrated schematically at 24) to the server 22. The server 22 is operable to store the information content 24. The information content 24 is sent to the server 22 as a datastream, and the first user machine 12 is operable (as will be described) to provide control content 26 associated with the information content 24. The server 22 is operable to prevent access to the information content 24 from the second user machine 14 except by a second user authorised by the control content 26.

In one example, the server 22 is operable in accordance with the control content 26 to prevent access to the information content 24 except by providing an image file representative of the information content and for viewing at the second machine 14. This may be a bitmap image file. Accordingly, in this example, a user of the second machine 14 is not forwarded the information content 24, but only an image of it, and is thus restricted in further handling of it.

### Structure of Machines

It is appropriate to discuss example structures for the user machines 12, 14 and the server 22 before embarking on a fuller description of their operation.

FIG. 2 illustrates one of the devices 12, 14, 22 in more detail. At the level of description necessary for a full understanding of the invention, the construction of the devices 12, 14, 22, and the function of the various components of the devices, is substantially the same or similar in each case. Accordingly, only one such device is described with a description which the skilled reader will readily be able to apply to each of the devices 12, 14, 22, having understood their various functions.

The device 12, 14, 22 is based around a processor 28. Memory 30 is associated with the processor 28. A bus 32 provides communication between the processor 28 and input/output systems 34. The input/output systems 34 provide a connection with the Internet 36. User facilities such as a display 38 and user controls 40 are also provided.

These may include a separate keyboard, mouse, or other cursor control device, monitor or other display device.

The memory 30 is divided into permanent memory 30 A, and temporary memory 30 B. In use, an operating system 42 is loaded to the memory 30 B to control the operation of the processor 28. An application 44 can be loaded to the memory 30 B to be executed within the operating system 42.

The application 44 may be delivered to the device 12, 14, 22 by wireless or wired communication, or by means of a storage medium 46 for communication with the device 12, 14, 22 by means of the input/output systems at 34. The application 44 consists of software providing instructions for the processor 28, to cause the processor 28 to execute the operations of the appropriate device 12, 14, 22 to be described below.

Having described an example architecture for use in constructing the machines 12, 14, 22, allowing them to function in accordance with instructions contained within the software application 44, their operation can now most clearly be described by reference to the functions performed under the control of the application software.

### First User Machine

The functions of the first user machine 12 are shown in the left column 48 of the flow diagram of FIG. 3. The functions relevant to the invention being described herein begin at the top of the column 48. The first user creates at 50 an electronic file of information content 24 which it is desired to communicate to a second user at the second user machine 14. The information content file may be in the format of a word processor file, or other format. The information content file is not in the format of an e-mail message.

The first user also creates a file of control content 26, at 52. The control content 26 contains information relating to a control policy imposed by the first user on the information content 24. The policy may determine the identity of the second user (or second users) for whom the information content 24 is intended, and may permit or prevent a range of actions of the second user, such as printing or saving the information content 24 on the second machine 14. The policy may also define an expiry date after which the second user will have no further access to the information content 24.

The creation of the information content 24 and the control content 26 is effected by a software application 54 illustrated in FIG. 2, preferably running as an add-in to the application 44 which is otherwise a conventional e-mail client application. This provides the first user with the facility to create content 24 for communication with the second user from within the e-mail client 44. It is expected that this will facilitate the process being described, for many users, in that they will be creating a communication with another user from within the e-mail client 44.

However, it is important to note that the application 54 does not create a conventional e-mail message for sending to the second user. Rather, the information content 24 and the control content 26 are sent at 58 to the server 22 in the form of a datastream. That is, the content 24, 26 is sent in the form of a stream of data routed in conventional manner from the first user machine 12 to the server 22, without copies being kept by intermediate machines through which the datastream is routed. The datastream may be encrypted, secure or otherwise protected. In one example, the datastream is sent over the internet 36 in the form of an HTTPS (Hypertext Transfer Protocol Secure) datastream.

### Server

The functions of the server 22 are shown in the middle column 59 of FIG. 3. At 60, the server 22 receives the datastream representing the information content 24 and the control content 26, all of which is stored at 62, within the server 22.

At 64, the server 22 opens an electronic log relating to the content 24, 26, thereafter recording all events relating to it. For example, the nature of any event will be recorded, together with the identity of the user creating the event. This provides a full audit trail relating to the content 24, for subsequent review if required.

The server 22 sends a confirmation of receipt at 66 to the first user, this being received at 68 by the first user. Conveniently, this confirmation of receipt may be sent as an e-mail message to be received by the first user within the e-mail client 44. Other message formats could be used, such as SMS (text), MMS or voice, and could be sent to the first user at the first user machine 12, or at another device, such as a portable communication device. The confirmation of receipt may indicate the size of the information content file which has been received by the server, the time of receipt and information relating to the integrity of the received file, such as a hash value. This allows the first user to confirm that the information content has been properly received by the server 22.

The server 22 sends a notification at 70 to the second user. In this example, the notification 70 is sent to the second user at the second user machine 16. The notification 70 may be in the form of an e-mail message to be received by the second user within an e-mail client, for convenience. It is to be noted that the notification does not contain the information content 24 or the control content 26. However, the notification 70 will include some information by which the information content 24 can be identified by the server 22 in subsequent operations. This may be a link, such as a hyperlink to the information content 24 stored within the server 22.

Other formats of electronic message could be used to send the notification 70, such as SMS (text), MMS or voice. Consequently, the notification 70 could be sent to the second user at a device other than the second user machine 16, such as a portable communication device.

### Second User Machine

The functions of the second user machine 14 are shown in the right column 73 of FIG. 3. After the second user has received the notification at 72, the second user is alerted by the notification that a communication intended for the second user is now available. The notification 70 may also indicate how access can be achieved, such as by indicating the authentication methods which will be required by the server 22. The second user uses the link information within the notification 72, such as a hyperlink, to attempt at 74 to access the information content 24 within the server 22, from the second user machine 14. The server 22 executes an authentication process at 76 before allowing access to the information content 24. This authentication process 76 may include the use of passwords or other conventional techniques, such as tokens, certificates, pre-known credentials etc. Thus, the server 22 undertakes a process of vetting and validation of the second user. Once the server 22 has determined at 76 that the user of the second user machine 14 is authorised to have access to the information content 24, in accordance with the control content 26 associated with the information content 24, the server 22 provides access at 77 to the information content 24.

The nature of the access which is allowed will depend on the control content 26. In one example, the control content 26 causes the server 22 to prevent access except by providing an image file representative of the information content 24. Thus, the information content 24 would be rendered as an image file, such as a bitmap image file, in this example. The image file is then provided for the second user to view at 78, for example through a browser application running on the second user machine 14.

In this example, the second user is conveniently able to read or view the information content 24 by looking at the image file provided by the server 22. However, the underlying file of information content 24 is not forwarded or copied to the second user machine 14. Accordingly, the second user is not able to operate on the file of information content 24, such as by saving it, printing it, amending it or forwarding it to other users. This maintains the integrity of the information content 24. Furthermore, this ensures that once the control content 26 indicates that an expiry date set by the first user has been reached, no further access to the information content 24 is provided by the server 22, for the second user.

The second user may be able to save a screen image created by the bitmap image file, while that is being viewed, but it would be evident that the resulting electronic file was not the original document and furthermore, would be very difficult to manipulate by amendment or otherwise, or to turn the image into a conventional document such as a word processing document. Thus, the first user maintains full control over the source document represented by the information content 24, by means of the instructions to the server 22, represented by the control content 26.

In other examples, the first user may consider it acceptable for the second user to download the original document from the server 22, in which case the control content 26 will authorise this.

### Further Features and Alternatives

The control content 26 created by the first user defines a policy relating to the information content 24 and may refer to various different factors, such as an expiry date for the information content (beyond which no access is permitted), information determining the authentication methods required of the second user, whether or not the second user is allowed to download the information content 24 or is only allowed to view a rendered image of it, whether or not the second user is allowed to print the information content 24, save it or forward it by e-mail etc. These choices can be made by the first user in accordance with the sensitivity and importance of the information contained within the information content 24. Once the policy has been created, the application software 56 allows the first user to select the same policy for use on a subsequent occasion. This allows, for example, a consistent policy to be implemented for a range of documents relating to a single matter.

The description above has referred to “a second user”. It is to be understood that this is for clarity and simplicity only and is not intended to indicate that the methods being described can only be used to communicate with a single other user. In one example, the application software 56 allows the first user to select a group of other users and to set control content 26 which defines a control policy consistent among the whole of the group, or different for different members of the group (perhaps according to their seniority within a corporation, for example). The control content 26 sent to the server 22 will include information relating to all of these factors, thus allowing the server 22 to implement the required policy. The server 22 will then act in relation to each of the users in the group, as described above in relation to “a second user”.

The first user has been described using a first user machine. The second user has been described using a second user machine. It is not necessary for each user to use a unique machine. In accordance with common practice, a user may be allowed to use multiple machines in which case, any machine currently being used by the first user becomes the first user machine, and any machine currently being used by the second user becomes the second user machine.

In one example, the first user can access and amend the control content 26 at any time after it has been sent to the server 22. For example, this would allow the first user to prevent the second user (or a selected second user) having further access to the information content.

In addition to maintaining a log, the server 22 may also send a message to the first user on each occasion that an event occurs in relation to the information content 24. For example, the first user may be notified of the identity of a second user who has accessed the information content 24.

Many variations and modifications can be made to the apparatus and methods described above, without departing from the scope of the present invention. In particular, the skilled reader will be aware of many different alternative hardware and software choices which could be made, while still allowing the described functions to be implemented. The description which has been provided, and the flow diagram in FIG. 3, indicate a time sequence in which various steps of the functions are implemented, but it is to be understood that in many cases, these steps can be implemented in other sequences, including sequences in which various steps are performed simultaneously.

It is apparent from the description set out above that the first user is able to communicate the information content 24 to another user or users, but to retain control over the information content 24 even after the other user or users have seen it. This contrasts with a conventional e-mail system, in which the sender loses control of information content once it has been received by the intended recipient.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. A system comprising first and second user machines and for providing communication of information content from the first user machine to the second user machine, the second user machine forming part of a network having security settings which are not controllable by use of the first user machine, the system further comprising:
a server;
the first user machine being operable to send information content to the server;
the server being operable to store the information content;
and wherein:
the information content is sent to the server as a datastream;
the first user machine is operable to provide control content associated with the information content; and
the server is operable to prevent access to the information content from the second user machine except by a second user authorised by the control content.

2. A system according to claim 1, wherein the server is operable in accordance with the control content to prevent access except by providing an image file representative of the information content and for viewing at the second user machine.

3. A system according to claim 2, wherein the image file is a bitmap image file.

4. A system according to claim 1, wherein the server is operable to allow the information content to be downloaded by a user authorised by the control content.

5. A system according to claim 1, wherein the server is operable to store the control content in association with the information content.

6. A system according to claim 1, wherein the server is operable to control operations on the information content in accordance with instructions contained in the control content.

7. A system according to claim 6, wherein the server is operable to maintain a log of operations carried out in relation to the information content.

8. A system according to claim 7, wherein the log contains information relating to operations carried out by the second user.

9. A system according to claim 1, wherein the server is operable to send link data to the second user, the link data alerting the second user to the presence of the information content.

10. A system according to claim 9, wherein the link data identifies the location of the information content.

11. A system according to claim 9, wherein the link data contains a hyperlink to the information content.

12. A system according to claim 9, wherein the link data is sent in the form of an electronic message to the second user, such as an e-mail, SMS, MMS, voice or other message format.

13. A system according to claim 9, wherein the link data is sent to the second user machine or to another machine.

14. A system according to claim 1, wherein the first user machine is operable from within an e-mail client to create the control content, the information content and the control content being sent by operation of the e-mail client.

15. A system according to claim 1, wherein the datastream is encrypted.

16. A system according to claim 15, wherein the datastream is secure.

17. (canceled)

18. A method for providing communication of information content from a first user machine to a second user machine, the second user machine forming part of a network having security settings which are not controllable by use of the first user machine, the method comprising:
providing a server;
using the first user machine to send information content to the server;
operating the server to store the information content;
and wherein:
the information content is sent to the server as a datastream;
the first user machine is used to provide control content associated with the information content; and
the server is used to prevent access to the information content from the second user machine except by a second user authorised by the control content.

19. A method according to claim 18, wherein the server is operated in accordance with the control content to prevent access except by providing an image file representative of the information content and for viewing at the second user machine.

20. A method according to claim 19, wherein the image file provides a bitmap image file.

21. A method according to claim 18, wherein the server is operated to allow the information content to be downloaded by a user authorised by the control content.

22. A method according to any of claim 18, wherein the server stores the control content in association with the information content.

23. A method according to any of claims 18, wherein the server controls operations on the information content in accordance with instructions contained in the control content.

24. A method according to claim 23, wherein the server maintains a log of operations carried out in relation to the information content.

25. A method according to claim 24, wherein the log contains information relating to operations carried out by the second user.

26. A method according to claim 18, wherein the server sends link data to the second user, the link data alerting the second user to the presence of the information content.

27. A method according to claim 26, wherein the link data identifies the location of the information content.

28. A method according to claim 26, wherein the link data contains a hyperlink to the information content.

29. A method according to claim 26, wherein the link data is sent in the form of an electronic message to the second user, such as an e-mail, SMS, MMS, voice or other message format.

30. A method according to claim 26, wherein the link data is sent to the second user machine or to another machine.

31. A method according to claim 26, wherein the first user machine is used from within an e-mail client to create the control content, the information content and the control content being sent by operation of the e-mail client.

32. A method according to claim 18, wherein the datastream is encrypted.

33. A method according to claim 18, wherein the datastream is secure.

34-42. (canceled)

43. A server for use in a system comprising first and second user machines and for providing communication of information content from the first user machine to the second user machine, the second user machine forming part of a network having security settings which are not controllable by use of the first user machine,
wherein the server is operable to receive a datastream from the first user machine and to identify information content and control content within the datastream, and to store the information content, and the server is further operable to prevent access to the information content from the second user machine except by a second user authorised by the control content.

44-55. (canceled)

56. A method for use in a system comprising first and second user machines and for providing communication of information content from the first user machine to the second user machine, the second user machine forming part of a network having security settings which are not controllable by use of the first user machine,
wherein the server is used to receive a datastream from the first user machine and to identify information content and control content within the datastream, and to store the information content, and the server is further used to prevent access to the information content from the second user machine except by a second user authorised by the control content.

57-69. (canceled)

70. Computer software which, when installed on a computer system, is operable as a system according to claim 1.

71. A carrier medium carrying computer software as defined in claim 70.

72. (canceled)
